(19) United States
(12) Patent Application Publication
(10) Pub. No.: US 2013/0319472 A1
(43) Pub. Date: Dec. 5, 2013

(54) METHOD AND APPARATUS FOR PROCESSING WAFER-SHAPED ARTICLES

(71) Applicants: Dieter FRANK, Velden (AT); Alexander LIPPERT, Villach (AT); Andreas GLEISSNER, Radenthein (AT)

(72) Inventors: Dieter FRANK, Velden (AT); Alexander LIPPERT, Villach (AT); Andreas GLEISSNER, Radenthein (AT)

(73) Assignee: LAM RESEARCH AG, Villach (AT)

(21) Appl. No.: 13/487,581

(22) Filed: Jun. 4, 2012

(51) Int. Cl. B08B 3/12; B08B 5/00; B08B 13/00

(52) U.S. Cl. 134/30; 134/115 R; 134/99.1; 134/34; 134/26

(57) ABSTRACT

A device and method for treating the surface of a semiconductor wafer provides a treatment fluid in the form of a dispersion of gas bubbles in a treatment liquid generated at acoustic pressures less than those required to induce cavitation in the treatment liquid. A resonator supplies ultrasonic or megasonic energy to the treatment fluid and is configured to create an interference pattern in the treatment fluid comprising regions of pressure amplitude minima and maxima at an interface of the treatment fluid and the semiconductor wafer. The resonator is mounted in the space between the rotary chuck body and a wafer carried in rotation with the chuck body; however, the resonator itself is stationary in relation to rotation of the wafer and chuck body.

### BACKGROUND OF THE INVENTION

1. Field of the Invention

The invention relates to methods and apparatus for processing wafer-shaped articles, and more particularly to methods and apparatus for megasonic cleaning of wafer-shaped articles.

2. Description of Related Art

Removal of particulate contaminants from a semiconductor substrate can be accomplished by ultrasonic cleaning. When the frequency of ultrasound is close to or above 1,000 kHz (1 MHz) it is often referred to as “megasonic”, and the term ultrasonic as used herein encompasses megasonic.

Commonly-owned application U.S. 2012/0073596 (corresponding to WO 2012/038933) describes improved techniques for ultrasonic cleaning of substrates, in which a bubble generator creates bubbles in a treatment fluid by a controlled decrease in pressure. This allows ultrasonic energy to be applied to the fluid at energy levels lower than those required to induce cavitation in the fluid.

However, there remains a need to improve megasonic cleaning techniques so as to more reliably remove nanoparticulate contamination without damaging the workpiece being processed, and without generating unacceptable cleaning patterns such as result from a non-uniform removal of contaminants. Shorter process times are also desired, as well as techniques that permit extending the process window and reducing the amount of control loops.

### SUMMARY OF THE INVENTION

It is accordingly an object of the present invention to produce a method and apparatus for treating articles that overcomes, at least in part, the disadvantages of the conventional art.

In one aspect, the present invention relates to an apparatus for processing wafer-shaped articles, comprising a chuck having a chuck body that is driven in rotation about an axis, and holding elements projecting from the chuck body and configured to position a lower surface of a wafer-shaped article a predetermined distance from the chuck body. The lower surface is preferably the device side of a semiconductor wafer. An acoustic resonator assembly is non-rotatably mounted on the chuck adjacent the chuck body such the acoustic resonator assembly is positioned between the chuck body and a wafer-shaped article when a wafer-shaped article is positioned by the holding elements at the predetermined distance from the chuck body.

In preferred embodiments of the apparatus according to the present invention, the chuck body is mounted for rotation about a stationary central shaft, and the acoustic resonator assembly is mounted in a cantilevered manner with a proximal end fastened to the central shaft and a distal end positioned above a peripheral region of the chuck body.

In preferred embodiments of the apparatus according to the present invention, the acoustic resonator assembly comprises a source of ultrasonic energy positioned so as to vibrate a fluid medium adjacent the article.

In preferred embodiments of the apparatus according to the present invention, a bubble generator is configured to produce a treatment fluid comprising a dispersion of gas bubbles having diameters ranging from 0.4 μm to 12 μm in a treatment liquid, the bubble generator being positioned adjacent the source of ultrasonic energy.

In preferred embodiments of the apparatus according to the present invention, the bubble generator is integrated into the acoustic resonator assembly.

In preferred embodiments of the apparatus according to the present invention, the holding elements are positioned and configured to hold a semiconductor wafer having a diameter of 300 or 450 mm.

In preferred embodiments of the apparatus according to the present invention, the source of ultrasonic energy is configured to generate an acoustic interference pattern in a treatment fluid comprising regions of pressure amplitude minima and maxima at an interface of the treatment fluid and a wafer-shaped article.

In preferred embodiments of the apparatus according to the present invention, the acoustic resonator assembly comprises a housing having an inlet opening for receiving a treatment fluid, a plurality of injection orifices or an injection slit provided in the housing, and a resonator positioned so as to generate an acoustic interference pattern adjacent the predetermined position.

In preferred embodiments of the apparatus according to the present invention, the acoustic resonator assembly is spaced from the predetermined position by 0.1 mm to about 10 mm.

In preferred embodiments of the apparatus according to the present invention, the acoustic resonator assembly comprises inlets communicating with supplies of at least three different treatment fluids.

In preferred embodiments of the apparatus according to the present invention, a second bubble generator is positioned so as to be spaced by 0.1 mm to about 10 mm from an upper surface of a wafer-shaped article positioned on the holding elements.

In preferred embodiments of the apparatus according to the present invention, the second bubble generator and a second source of ultrasonic energy are integrated in a second acoustic resonator assembly.

In another aspect, the present invention relates to a method for treating wafer-shaped articles, comprising positioning a wafer-shaped article on holding elements projecting from a chuck body of a chuck, rotating the chuck body and the wafer-shaped article about an axis of rotation and contacting a surface of the wafer-shaped article facing the chuck body with an ultrasonically energized treatment fluid comprising a dispersion of gas bubbles in a liquid. An acoustic resonator assembly is non-rotatably mounted on the chuck adjacent the chuck body such the acoustic resonator assembly is positioned between the chuck body and the wafer-shaped article.

In preferred embodiments of the method according to the present invention, the surface of the wafer-shaped article facing the chuck body is contacted with another treatment gas or liquid dispensed from the acoustic resonator assembly before or after the contacting step.

In preferred embodiments of the apparatus according to the present invention, a surface of the wafer-shaped article facing away from the chuck body is contacted with an ultrasonically energized treatment fluid comprising a dispersion of gas bubbles in a liquid.

### BRIEF DESCRIPTION OF THE DRAWINGS

The invention will be more fully understood from the following detailed description of various preferred embodiments thereof, which are given by way of non-limiting example, and taken with reference to the accompanying drawings, in which:

FIG. 1 is a perspective and axial sectional view of an embodiment of the apparatus according to the present invention, with a wafer-shaped article positioned thereon so as to practice the method according to the present invention;

FIG. 2 is a plan view of the embodiment of FIG. 1, without a wafer-shaped article in position;

FIG. 3 is an axial section along the line III-III of FIG. 2;

FIG. 4 is an axial section along the line IV-IV of FIG. 2;

FIG. 5 is a perspective view from above of an acoustic resonator assembly according to an embodiment of the present invention;

FIG. 6 is a perspective view from below of the acoustic resonator assembly of FIG. 5; and

FIG. 7 is a view corresponding to that of FIG. 4, of an alternative embodiment of an apparatus according to the present invention.

### DETAILED DESCRIPTION

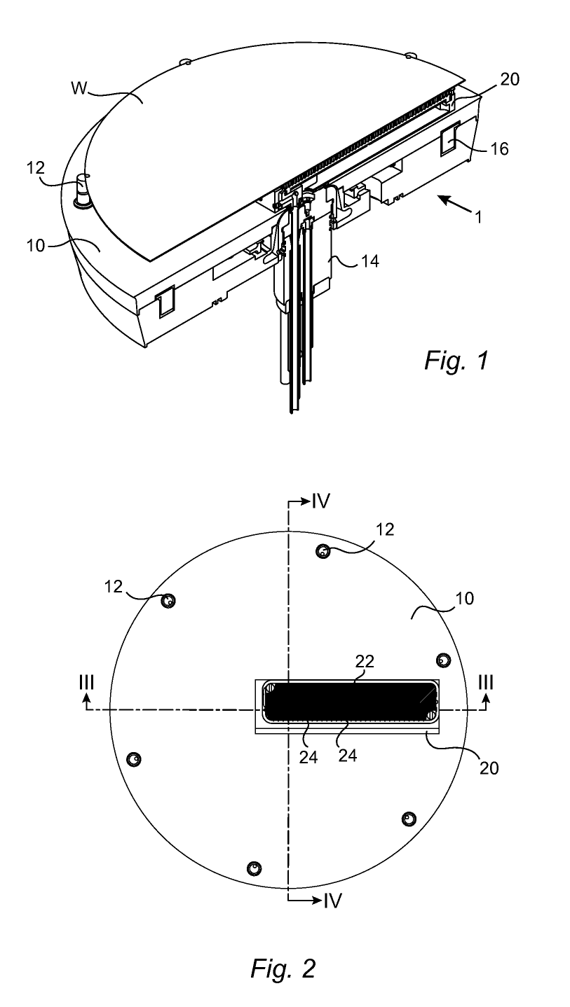

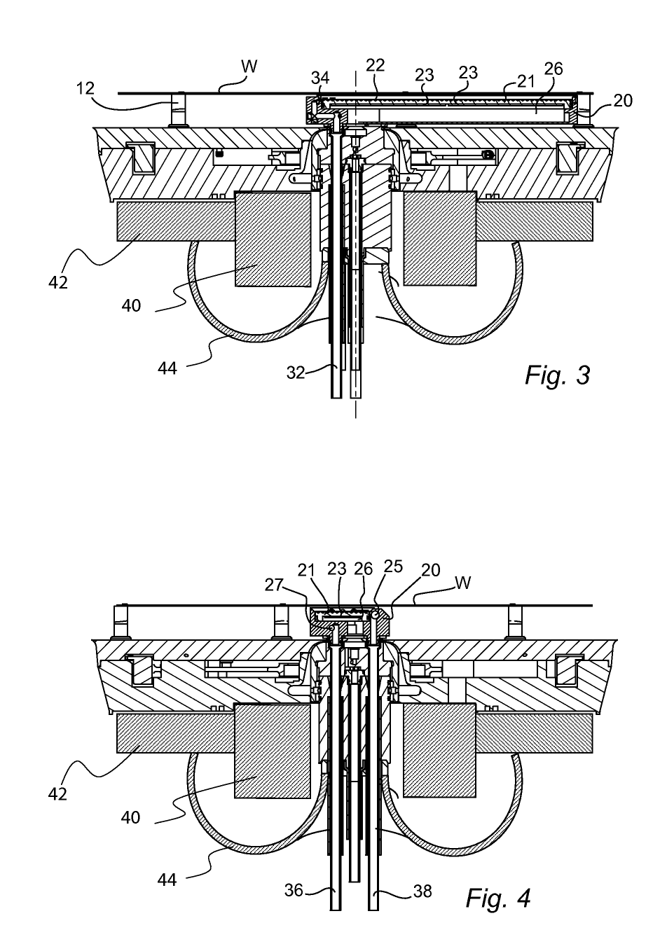

In FIG. 1, a spin chuck 1 comprises a chuck body 10 that is mounted for rotation about a stationary hollow shaft 14. Spin chuck 1 is mounted to the rotor of a hollow-shaft motor (schematically shown in FIG. 3), and the stationary shaft 14 penetrates through a central opening of the chuck body 10. The stator of the hollow-shaft motor 40 is mounted to the mounting plate 42 (schematically shown in FIG. 3). Stationary shaft 14 and mounting plate 42 are mounted to the same stationary frame 44 (schematically shown in FIG. 3).

Although not shown in the figures, the spin chuck may be surrounded by a process chamber, which may be a multi-level process chamber as described in commonly-owned U.S. Pat. No. 7,837,803 (corresponding to WO 2004/084278). The spin chuck can be positioned at the selected level by moving the chuck axially relative to the stationary surrounding chamber, or by moving the surrounding chamber axially relative to the axially-stationary chuck, as described in connection with FIG. 4 of U.S. Pat. No. 6,536,454.

A wafer W is held with its lower surface a predetermined distance from the chuck body 10, by a series of gripping pins 12 that project upwardly from the chuck body 10. Gripping pins 12 are driven in concert by a ring gear 16, from an open position in which the upper eccentric gripping portions of pins 12 are positioned radially outwardly of the wafer edge, to a closed position in which the eccentric gripping portions engage the wafer edge. A given chuck will typically be designed to accommodate wafers of a specified standard diameter, and it is preferred that the present chuck be configured to hold a semiconductor wafer whose diameter is 300 mm or 450 mm, or whose diameter varies from those values within the tolerances specified in the applicable standard.

Also visible in FIG. 1 is an acoustic resonator assembly 20, which is present in the space between the lower surface of wafer W and the upper surface of chuck body 10. Acoustic resonator assembly is fixed at its proximal, or central, end to the hollow shaft 14, whereas the distal, or peripheral, end of acoustic resonator assembly is spaced from chuck body 10 and is supported in a cantilevered manner by the connection of the proximal end to shaft 14.

In FIG. 2 the chuck of FIG. 1 is shown in plan view with the wafer W removed. The series of parallel lines 22 on the upper surface of the acoustic resonator assembly indicates a series of triangular grooves formed in a structured solid element. One or more piezoelectric crystals are affixed to the underside of the structured solid element, and together they form a resonator. This resonator is electrically driven at a resonance frequency, which corresponds to one of the structural resonances of the resonator and varies typically between 10 kHz and 10 MHz. The solid element is configured to generate a specific acoustic interference pattern when a wafer W is positioned adjacent the resonator and the gap therebetween is filled with a liquid. A typical example of a series of triangular grooves 22 is one having typical dimension for the base and the height of each triangle of between 500 micrometer and 1 cm. The gap between the underside of wafer W and resonator assembly 20 is typically on the order of 100 micron to about 10 mm, preferably 0.2 mm to 6 mm, and more preferably 0.2 mm to 3 mm.

The structured solid element could be made out of aluminum, sapphire, silicon or quartz, or any other suitable material. The grooves 22 may be exposed, or may be covered by a plastic or polymer coating. The thickness of this coating is preferably between 1 μm and 100 μm.

The resulting acoustic interference pattern forms alternating regions of pressure amplitude maxima and minima within the liquid and at the solid-liquid interface at the wafer W. If bubbles are injected in the developed acoustic field, they will be sorted, depending on their size, towards the pressure amplitude maxima and minima. In a relatively weak acoustic field, a bubble driven below resonance (which means that the driving frequency of the imposed ultrasound field is below the fundamental resonance frequency of the bubble (calculated by the Minnaert equation)) moves to the pressure amplitude maximum. The bubbles typically grow due to coalescence in the pressure maxima until they reach the critical size given by the Minnaert equation they will start moving towards a pressure amplitude minimum.

Also visible in FIG. 2 is a series of small openings 24 formed along one side of the body of the acoustic resonator assembly 20, and communicating with an interior chamber into which a precursor of the treatment fluid is introduced. One example of such a precursor is pressurized deionized water. These openings 24 constitute injection orifices for the treatment fluid or deionized water. Although 32 injection orifices are shown in this embodiment, there can be a wide range in the number of injection orifices ranging from about 1 to about 30 per 100 mm², preferably about 16 per 100 mm². The injection orifices 24 have a diameter from about 50 μm to about 500 μm, but preferably between 100 and 350 μm and are designed to create a pressure drop in the medium between the interior of the resonator body and the gap between the resonator assembly 20 and wafer W into which the treatment fluid is introduced.

Furthermore, it has been found that operating in an acoustic pressure range of from 10⁻³ bar to 10³ bar allows to manage (in combination with the selected operational frequency) the bubble activity, which allows bubbles to create surface modes, surface instabilities, volumetric oscillations even leading to heavy collapsing bubbles, and therefore can create acoustic streaming, shear stress or enrich the liquid-solid interface with one or more gaseous components.

Besides the in situ heterogeneous nucleation of bubbles in the liquid, it is especially beneficial to inject bubbles directly in to the liquid, which allows to operate at acoustic pressure below the cavitation threshold (typically lower than 1 bar). Furthermore, bubble size distribution and content of the bubbles can be more easily tuned towards the targeted application.

FIG. 3 shows a first axial section through the chuck of this embodiment, with a wafer W once again shown positioned on the chuck. The structured solid element 21 comprises triangular grooves 22 as discussed above. Two piezoelectric crystals 23 are affixed to the underside of the structured solid element 21. The acoustic resonator assembly 20 is formed with an interior chamber 26, which accommodates the electrical connections (not shown) for powering the piezoelectric crystals 23. Conduit 32 is connected to a source of nitrogen gas. Conduit 32 terminates in an angled discharge nozzle 34 formed in the body of the acoustic resonator assembly In FIG. 4, the axial section has been turned90° from that of FIG. 3. This reveals the conduit 38 that supplies the pressurized treatment fluid to the distribution manifold 25, which in turn communicates with openings 24. Before the treatment liquid such as DI water can be brought into the gap between the structured solid element 21 and the wafer W, the gap should be filled with another treatment liquid, for example SC-1, SC-2 or the like, through connection 36. This gap filling process is preferably done in such a way that the gap is filled with treatment liquid including as few air bubbles as possible. The treatment liquid precursor is a liquid having a gas dissolved therein in the pressurized state, such that passage of this liquid through openings 24 causes a controlled pressure drop in the liquid, which in turns leads to bubbles of the dissolved gas coming out of solution.

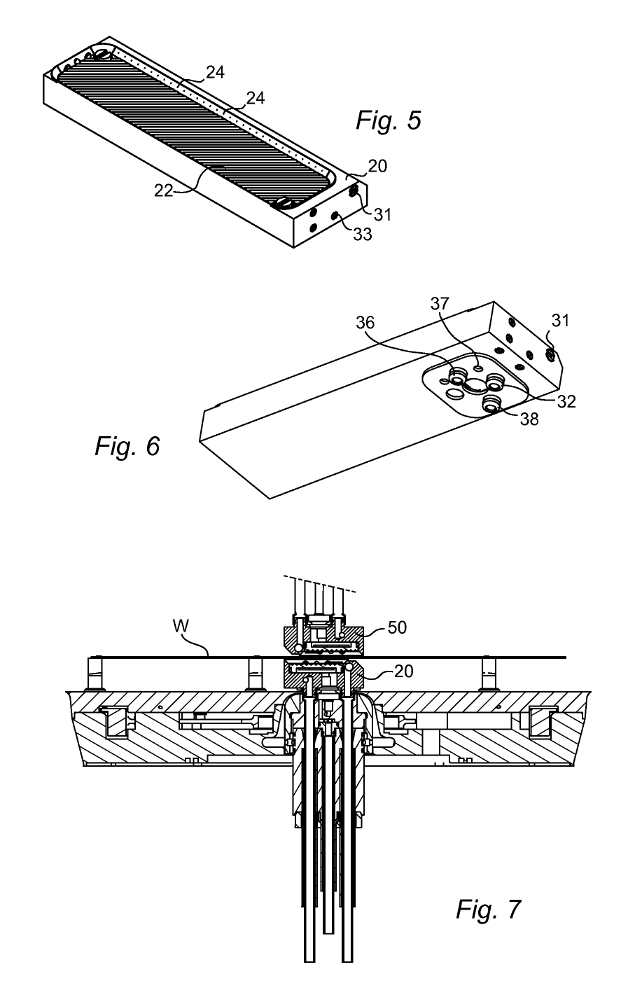

In FIG. 5 the acoustic resonator assembly 20 is shown in greater detail, where it can be seen that the openings 24 are formed in an angled surface of the resonator body. That is, the openings 24 direct treatment fluid into the space between the resonator and the wafer W at an oblique angle to the lower surface of wafer W. Valves 33 and 31 permit access to nozzle 34 and distribution manifold 25, respectively, to clean and purge those passageways when the chuck is not in service.

Although as noted above the openings 24 have a diameter from about 50 μm to about 500 μm, and preferably between 100 and 350 μm, the bubbles that come out of solution upon the treatment fluid passing through these openings are much smaller. In particular, the bubble size distribution in the treatment fluid is preferably such that 90% of the bubbles have a bubble diameter d wherein 0.8*ds≦d≦1.2*ds, where ds is a selected number in the range of about 0.5 μm to about 10 μm, and preferably less than about 5 μm.

Although the bubbles are created by the pressure drop as the treatment liquid passes through openings 24, rather than by nucleation induced by the megasonic radiation, the size to which the bubbles grow is nevertheless a function of the wavelength of the megasonic radiation emitted by the resonator. For example, when the resonator generates megasonic radiation of 1 MHz, this corresponds to a wavelength λ=1.48 mm, which in turn leads to ds=λ/500, and a bubble diameter of about 3 μm. The preferred ranges of bubble diameters for use in the present method and apparatus are 0.4-12 μm, preferably 1-8 μm, and more preferably 2-5 μm.

If the openings 24 were substantially smaller, for example on the order of the bubble diameter, then greater pressure would be required to force the treatment fluid through the openings 24. That higher pressure would cause the bubbles to come out of solution at a point more distant from the resonator, and would thereby inhibit the efficacy of the megasonic cleaning or render the bubbles ineffective altogether. The gap between the resonator and the wafer can be filled via supply connection 36. Connection 32 is preferably used for nitrogen gas supply.

In FIG. 6, bosses for the attachment of conduits 32, 36 and 38 are visible, as are openings 37 through which the proximal end of the resonator assembly may be rigidly secured to the hollow shaft 14.

Lastly, FIG. 7 shows an alternative embodiment from the same vantage as FIG. 4, where the chuck includes also an upper resonator assembly 50, which is constructed and positioned in the same manner as described in connection with the resonator assembly 20, but on the opposite side of the wafer. This arrangement permits increased cleaning throughput by cleaning both sides of a wafer W simultaneously.

Although FIG. 7 shows the topside resonator assembly as having the same components as the lower resonator assembly 20, it is also contemplated that the topside assembly 50 may omit the resonator components, and instead be solely a bubble generator and perhaps also a dispenser of other treatment fluids. This simplified construction of the topside assembly is possible when the megasonic radiation emitted by the lower assembly 20 sufficiently passes through the thickness of wafer W so as to energize the bubbles generated by assembly 40 in addition to those generated by assembly 20.

What is claimed is:

1. An apparatus for processing wafer-shaped articles, comprising:
a chuck having a chuck body that is driven in rotation about an axis, and holding elements projecting from said chuck body and configured to position a lower surface of a wafer-shaped article at a predetermined distance from said chuck body; and
an acoustic resonator assembly non-rotatably mounted on said chuck adjacent said chuck body such said acoustic resonator assembly is positioned between said chuck body and a wafer-shaped article when a wafer-shaped article is positioned by said holding elements at said predetermined distance from said chuck body.

2. The apparatus according to claim 1, wherein said chuck body is mounted for rotation about a stationary central shaft, and wherein said acoustic resonator assembly is mounted in a cantilevered manner with a proximal end fastened to said central shaft and a distal end positioned above a peripheral region of said chuck body.

3. The apparatus according to claim 1, wherein said acoustic resonator assembly comprises a source of ultrasonic energy positioned so as to vibrate a fluid medium adjacent the article.

4. The apparatus according to claim 3, further comprising a bubble generator configured to produce a treatment fluid comprising a dispersion of gas bubbles having diameters ranging from 0.4 μm to 12 μm in a treatment liquid, said bubble generator being positioned adjacent said source of ultrasonic energy.

5. The apparatus according to claim 4, wherein said bubble generator is integrated into said acoustic resonator assembly.

6. The apparatus according to claim 1, wherein said holding elements are positioned and configured to hold a semiconductor wafer having a diameter of 300 or 450 mm.

7. The apparatus according to claim 3, wherein said source of ultrasonic energy is configured to generate an interference pattern in a treatment fluid comprising regions of pressure amplitude minima and maxima at an interface of the treatment fluid and a wafer-shaped article.

8. The apparatus according to claim 1, wherein said acoustic resonator assembly comprises a housing having an inlet opening for receiving a treatment fluid, a plurality of injection orifices or an injection slit provided in said housing, and a resonator positioned so as to generate an interference pattern adjacent said predetermined position.

9. The apparatus according to claim 8, wherein said acoustic resonator assembly is spaced from said predetermined position by 0.1 mm to about 10 mm.

10. The apparatus according to claim 1, wherein said acoustic resonator assembly comprises inlets communicating with supplies of at least three different treatment fluids.

11. The apparatus according to claim 4, further comprising a second bubble generator positioned so as to be spaced by 0.1 mm to about 10 mm from an upper surface of a wafer-shaped article positioned on said holding elements.

12. The apparatus according to claim 11, further comprising a second acoustic resonator assembly, and wherein said second bubble generator and a second source of ultrasonic energy are integrated in said second acoustic resonator assembly.

13. A method of treating a wafer-shaped article, comprising:
positioning a wafer-shaped article on holding elements projecting from a chuck body of a chuck;
rotating the chuck body and the wafer-shaped article about an axis of rotation; and
contacting a surface of the wafer-shaped article facing the chuck body with an ultrasonically energized treatment fluid comprising a dispersion of gas bubbles in a liquid;
wherein an acoustic resonator assembly is non-rotatably mounted on the chuck adjacent the chuck body such the acoustic resonator assembly is positioned between the chuck body and the wafer-shaped article.

14. The method according to claim 13, further comprising contacting the surface of the wafer-shaped article facing the chuck body with another treatment gas or liquid dispensed from the acoustic resonator assembly before or after said contacting step.

15. The method according to claim 13, further comprising contacting a surface of the wafer-shaped article facing away from the chuck body with an ultrasonically energized treatment fluid comprising a dispersion of gas bubbles in a liquid.
